(19) United States
(12) Patent Application Publication
(10) Pub. No.: US 2006/0086053 A1
(43) Pub. Date: Apr. 27, 2006

(54) Lightweight glass-run channels

(76) Inventor: Peter John Ellis, Rochester Hills, MI (US)

Correspondence Address: Mr. Robin W. Asher;Clark Hill PLC, Suite 3500, 500 Woodward Avenue, Detroit, MI, 48226-3435, US

(21) Appl. No.: 11/255,513

(22) Filed: Oct. 21, 2005

Related U.S. Application Data
(60) Provisional application No. 60/622,639, filed on Oct. 27, 2004.

(51) Int. Cl. E06B 7/16

(52) U.S. Cl. 49/441

(57) ABSTRACT

A glass-run channel comprising a U-channel including a shoulder, an inboard leg, and an outboard leg wherein at least one of the shoulder, inboard leg, and outboard leg is characterized by a specific gravity of less than 0.85, a first lip carried by the inboard leg, and a second lip carried by the outboard leg where at least one of the first and second lips are characterized by a specific gravity of greater than about 0.80.

### BACKGROUND OF THE INVENTION

1. Field of the Invention

This invention relates to glass-run channels that are advantageously light weight; the advantageous weight resulting from at least a portion of the glass-run channel having a relatively low specific gravity.

2. Description of the Related Art

Weather seals or weather stripping is commonly employed in automobiles. The weather stripping seals gaps that are present between the body and a panel when the panel is in a closed position. The panels typically include door panels, hatchback panels, trunk panels, window panels and sliding roof panels. For example, U.S. Pat. No. 6,716,496 teaches a weather stripping extrudate that includes an attachment portion formed of solid rubber and a lip portion, which forms a hollow loop-shaped structure formed of a sponge rubber. In the case of an automobile trunk, when the trunk is in its closed position, an inboard portion of the trunk will contact the hollow, loop-shaped structure and thereby cause the structure to deform and create a seal between the trunk and the body.

Another form of weather seal or weather stripping includes a glass-run channel. As with other forms of weather stripping, the glass-run channel serves to seal a gap that exists between components of an automobile. Specifically, the glass-run channel seals the gap that exists between a movable window and the frame in which the window is secured when in the upright position. This will typically involve the upper frame portion of an automobile door, For example, and as shown in FIG. 1, the upper portion 502 of automobile door 501 includes A pillar 503, B pillar 504, and header 505. When movable window 508 is in its upright position, the upper edges 509 of window 508 will either contact or become proximal to the A pillar 503, B pillar 504, or header 505. It is common in the art to secure a glass-run channel in the A pillar 503, B pillar 504, and header 505 so that the window 508 can sealingly engage the upper portion 502 of door 501 and thereby prevent the entry of wind or water into the automobile when the window is in its upright or closed position.

A common configuration of a glass-run channel is shown at 510 in FIG. 2. The glass-run channel 510 includes a U channel 511, which comprises inboard leg 512, outboard leg 513, and shoulder 514. Inboard leg 512 carries inboard lip 516 and outboard leg 513 carries outboard lip 517. Shoulder 514 typically carries a wind lip 518 or bumper. Inboard lip 516, outboard lip 517, and wind lip 518 typically carry low friction layers, which are shown as first low friction layer 519, second low friction layer 520, and third low friction layer 521.

Typical glass-run channels also include at least one retainer portion, which serves as a means of retaining the glass-run channel into the body of an automobile. In the art, these retainers can be supported or unsupported. For example, and as shown in FIG. 2, glass-run channel 510 includes first retention portion 524 and second retention portion 525. As a result of this configuration, this channel is unsupported. On the other hand, FIG. 3 shows a supported glass-run channel 530, which includes U Channel 531, inboard leg 532, outboard leg 533, and shoulder 534. Inboard leg 532 carries lip 536, outboard leg 533 carries lip 537, and shoulder 534 carries bumper 538. In lieu of retention portion, channel 530 includes a supported retention arm 540, which includes metal support 541.

Unlike the tubular weather stripping that is typically employed to seal gaps associated with the trunk panel or door panels, the glass-run channels operate quite differently. To begin with, the tubular weather stripping is specifically designed to be compressed when engaged by the body panel. This ability to compress is typically achieved based upon the tubular nature of the weather stripping as well as the material used to fabricate the weather stripping. As noted above, this tubular weather stripping is often made of foamed rubber.

In contradistinction, the sealing portion of the glass-run channel is not tubular in nature, Instead, the glass-run channel forms a housing into which the glass can reside. In the case of the A and B pillars 503 and 504, the glass will move longitudinally through the length of the glass-run channel; and in the case of the header, the glass will move laterally into the glass-run channel. Also, the various components of the glass-run channel are resilient, particularly the lips.

The ability to seal against the glass does not result solely from compressive forces of the glass (as it does in the ease of a tubular weather seal mating with a trunk panel). Because the glass-run channel mates with or seals the glass in a different manner than tubular weather stripping, the mechanical properties associated with the components of the glass-run channel are quite distinct. Indeed, the inboard and outboard legs, the shoulder, and the sealing lips have heretofore been made of solid rubber. The solid rubber is ideally characterized by relatively high compression low deflection and relatively low compression set, particularly after heat aging and cycling (i.e., repeated movement of the glass through the channel).

While the use of solid rubber to form the components of the glass-run channel has proven to be technologically useful, the density of the rubber and the weight associated therewith increases the overall weight of an automobile. As the desire for lightweight vehicles having improved fuel efficiency increases, the need to develop lighter glass-run channels also increases.

### SUMMARY OF THE INVENTION

In general the present invention provides a glass-run channel comprising a U-channel including a shoulder, an inboard leg, and an outboard leg where at least one of the base, inboard leg, and outboard leg is characterized by a specific gravity of less than 0.85, a first lip carried by the inboard leg, and a second lip carried by the outboard leg where at least one of the first and second lips are characterized by a specific gravity of greater than about 0.80.

The present invention also includes a glass-run channel comprising a U-channel including a shoulder, an inboard leg, and an outboard leg where at least one of the base, inboard leg, and outboard leg is characterized by a specific gravity of less than 0.85, and at least one lip carried by at least one of the inboard leg and the outboard leg, where at least one lip is characterized by a specific gravity of greater than about 0.80.

### BRIEF DESCRIPTION OF THE DRAWINGS

Advantages of the present invention will be readily appreciated as the same becomes better understood by reference to the following detailed description when considered in connection with the accompanying drawings, wherein:

FIG. 1 is a side view of an automobile as is known in the prior art;

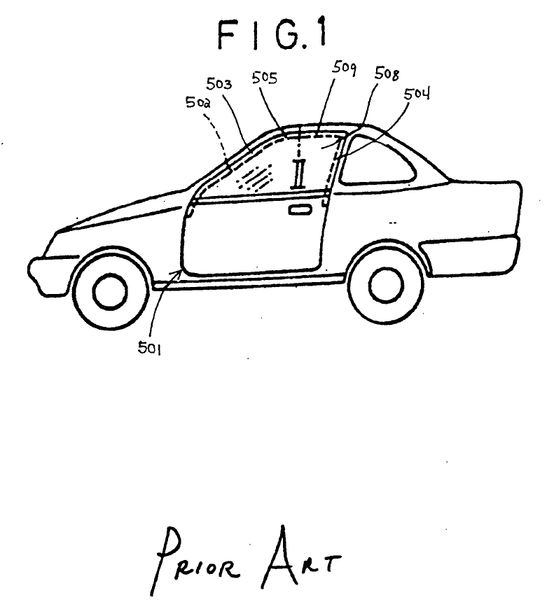

FIG. 2 is a cross-sectional view of an unsupported glass-run channel as is known in the prior art;

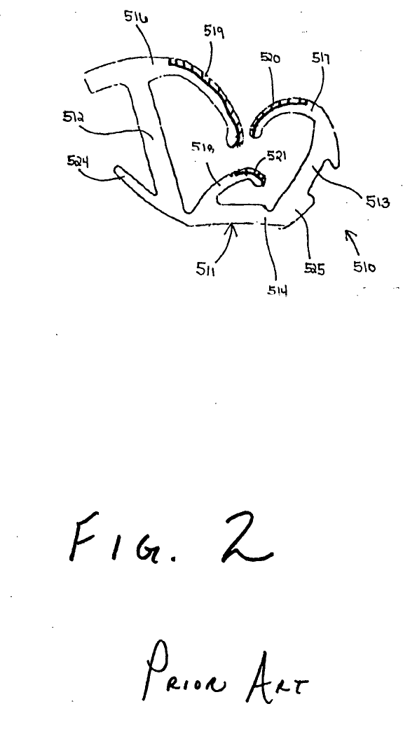

FIG. 3 is a cross-sectional view of a supported glass-run channel as is known in the prior art;

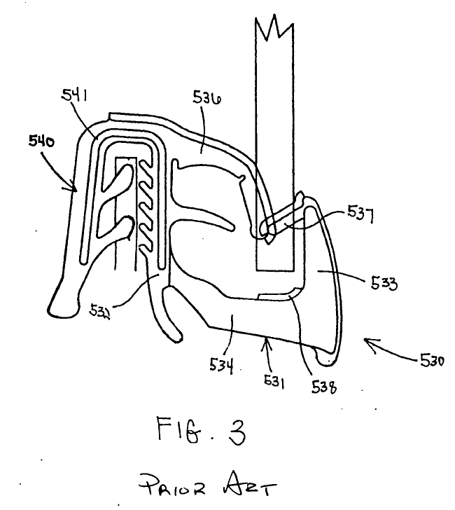

FIG. 4 is a cross-sectional view of an unsupported glass-run channel including a wind-noise lip according to the present invention;

FIG. 5 is a cross-sectional view of an unsupported glass-run channel including a bumper according to the present invention; and

FIG. 6 is a cross-sectional view of a supported glass-run channel including a bumper according to the present invention.

### DETAILED DESCRIPTION OF ILLUSTRATIVE EMBODIMENTS

In general, the glass-run channels of this invention are uniquely lightweight because at least a portion of the U-channel has a relatively low specific gravity as compared to the contact lips.

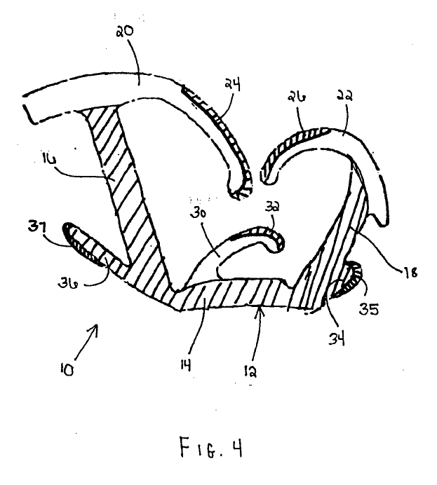

One embodiment of this invention is shown in FIG. 4 where an unsupported glass-run channel 10 includes U-channel 12, first contact lip 20, second contact lip 22, optional wind-noise lip 30, first retention portion 34, and second retention portion 36.

U-channel 12 includes shoulder portion 14, inboard leg 16, and outboard leg 18. At least one of the shoulder portion 14, inboard leg 16, and outboard 25 leg 18 is characterized by having a relatively low specific gravity. Preferably, the specific gravity of at least one of the shoulder 14, inboard leg 16, and outboard leg 18 is less than 0.80, in other embodiments less than about 0.75, in still other embodiments less than about 0.70, and yet in other embodiments less than about 0.65, as determined according to ASTM D297. In one embodiment, both inboard leg 16 and outboard leg 18 are both characterized by a relatively low specific gravity. In another embodiment, inboard leg 16, outboard leg 18, and shoulder 14 are all characterized by a relatively low specific gravity.

In one or more embodiments, the relatively low specific gravity of the one or more components may be achieved by foaming a polymeric material. The polymeric materials may include thermoplastic resins, rubber, or blends of thermoplastic resins and rubbers. In one preferred embodiment, the polymeric material that is foamed to form the low specific gravity component includes thermoplastic vulcanizates, which include cured rubber dispersed throughout a thermoplastic matrix; these blends are prepared by dynamic vulcanization techniques. These techniques, as well as the thermoplastic vulcanizates resulting therefrom, are known as disclosed in U.S. Pat. Nos. 4,311,628 and 6,433,090, which are incorporated herein by reference. Preferred thermoplastic vulcanizate compositions can be obtained under the tradename SANTOPRENE™ (Advanced Elastomer Systems: Akron, Ohio). In other embodiments, the polymeric material that is foamed may include art olefinic elastomeric copolymer such as ethylenepropylene-diene terpolymer (a.k.a EPDM).

Methods for foaming polymeric materials are known in the art. For example, where thermoplastic vulcanizates are employed as the polymeric material, these procedures include (i) heating the thermoplastic vulcanizate to a temperature above the melting point of conventional thermoplastic resin, random propylene copolymer, or both, (ii) adding a blowing agent, and (iii) releasing the thermoplastic vulcanizate to atmospheric temperature and pressure. Depending on the type of blowing agent employed, the blowing agent may be added to the thermoplastic vulcanizate prior to heating the thermoplastic vulcanizate in the foaming process, although it is preferred to add the blowing agent to the thermoplastic vulcanizate while it is in its molten state. Also, high pressure is typically required to prevent the foaming agent from prematurely expanding prior to releasing the thermoplastic vulcanizate to atmospheric temperature and pressure. Where a chemical blowing agent is employed, the step of heating should heat the thermoplastic vulcanizate and blowing agent high enough to trigger the chemical decomposition of the blowing agent.

In one embodiment, the thermoplastic vulcanizates are foamed by using an extruder, such as a single or twin screw extruder. Upon releasing the thermoplastic vulcanizate from the extruder, the extrudate can be shaped, such as by extruding through a shaping die to form a profile. Alternatively, the thermoplastic vulcarnizate can be injected into a mold to produce a foamed thermoplastic part.

In one embodiment, the thermoplastic vulcanizate is foamed by using a single screw extruder that includes a two-stage shearing section that includes spaced blisters and a homogenizing section between the blisters, as well as a homogenizing section downstream of the blisters. By using this extruder, water can be used as a blowing agent. This extruder and the method for its use are disclosed in U.S. Pat. No. 5,567,370, which is incorporated herein by reference.

The foaming agents may include physical blowing agents, chemical blowing agents, or both. Where thermoplastic vulcanizates are foamed, the blowing agents are preferably soluble in the thermoplastic phase of the thermoplastic vulcanizate at the operating conditions of temperature and pressure, i.e., while in the extruder, and phase separate at atmospheric pressure and ambient temperature, or at a temperature and pressure that is lower than the conditions within the extruder.

The physical blowing agents may include water, hydrocarbons such as pentane, propane and butane, fluorocarbons, hydrofluorocarbons, chlorofluorocarbons, hydrochlorofluorocarbons, nitrogen, and super critical fluids such as carbon dioxide.

In one or more embodiments, the physical blowing agents may be used in an amount from about 0.1 to about 10 parts by weight, or from about 0.5 to about 5 parts by weight, based on the total weight of the thermoplastic vulcanizate and the blowing agent mixture.

In one embodiment, water is used as a blowing agent. In certain embodiments, from about 0.1 to about 10 parts by weight water is added per 100 parts by weight of the thermoplastic vulcanizate. In conjunction with the water, detergents, surfactants, or glycols such as ethylene glycol, may be used. One process for foaming the thermoplastic vulcanizates is disclosed in U.S. Pat. No. 5,070,111, which is incorporated herein by reference.

Chemical blowing agents include both exothermic and endothermic blowing agents. Examples of these chemical blowing agents include inorganic foaming agents such as sodium hydrogen carbonate, sodium carbonate, ammonium hydrogen carbonate, ammonium carbonate and ammonium nitrite; nitrous compounds such as N,N′.dimethyl-N,N′-dinitrosoterephthalamide and N, N′dinitrosopentamethylenetetramine; azo compounds such as azodicarbonamide, azobisisobutyronitrile, azocyclohexyInitrile, azodlaminobenzene and barium azodicarboxylate; suit onylhydrazide compounds such as benzenesulfonylhydrazide, toluenesulfonylhydrazide, p, p′oxybis(benzenesulfonylhydrazide) and diphenylsulfone-3, 3′-disulfonylhydrazide; and aside compounds such as calcium azide, 4,4′-diphenyldisulfonylazide and p. toluenesulfonylazide. Blends of the foregoing may also be employed such as blends of citric acid and sodium bicarbonate.

In one embodiment, chemical blowing agents may be used in an amount from about 0.5 to about 10 parts by weight, or from about 1 to about 7 parts by weight, based on the total weight of the thermoplastic vulcanizate and the blowing agent mixture combined.

If necessary, a foaming assistant such as a nucleating agent may be added. These nucleating agents are known in the art as disclosed in THERMOPLASTIC FOAMS, by J. L. Throne, Sherwood Publishers, Hinckley, Ohio, 1996, which is incorporated herein by reference.

First and second contact lips 20 and 22 are preferably characterized by mechanical properties that allow them to be technologically useful in application. For example, the lips of one or more embodiments are preferably characterized by advantageous compression load deflection and compression set, especially after heat aging. Accordingly, in one or more embodiments, first and second contact lips 20 and 22 are characterized by a relatively high specific gravity. Preferably, the specific gravity of at least one of the first and second lips is greater than 0.80, in other embodiments greater than about 0.85, in other embodiments greater than about 0.90, and in other embodiments greater than about 0.95, as determined according to ASTM 0297.

In one or more embodiments, the relatively high specific gravity of one or more of the components may be achieved by extruding or molding a polymeric material. The polymeric materials that can be employed include those conventionally employed in the art of making window channels including, but not limited to thermoplastic resins, rubber, or blends of thermoplastic resins and rubber (e.g. thermoplastic vulcanizates). In fact, many conventional materials are known in the art as disclosed in, for example, U.S. Pat. Nos. 5,110,685, 4,894,408, 6,602,589, 6,368,700, and RE 35,398, which are incorporated herein by reference. In one embodiment, those elements having a relatively high specific gravity are prepared with SANTOPRENE™.

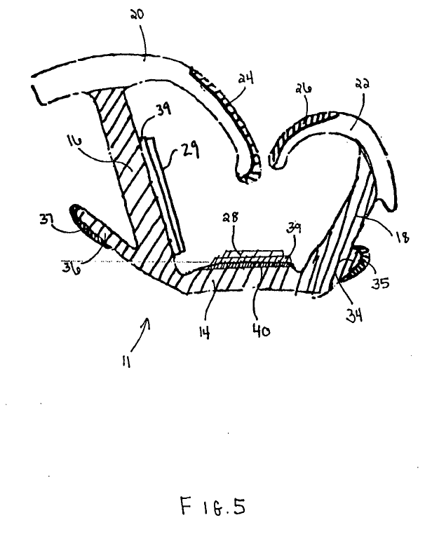

Practice of this invention is not necessarily limited by the particular type of window channel. In other words, several types of supported and unsupported glass-run channels, each having varying configurations, are known in the art, and the benefits of this invention can be realized in many of these types or configurations. For example, another embodiment is shown in FIG. 5 where unsupported glass-run channel 11 includes a U channel 12, first contact lip 20, second contact lip 22, bumper 40, first retention portion 34, and second retention portion 36. U channel 12 includes shoulder portion 14 (which is primarily comprised of bumper 40, in board leg 16, and outboard leg 18). As with the previous embodiment, at least one of shoulder portion 14, inboard leg 16, and outboard leg 18 is characterized by having a relatively low specific gravity. Bumper 40 is likewise characterized by having a relatively low specific gravity.

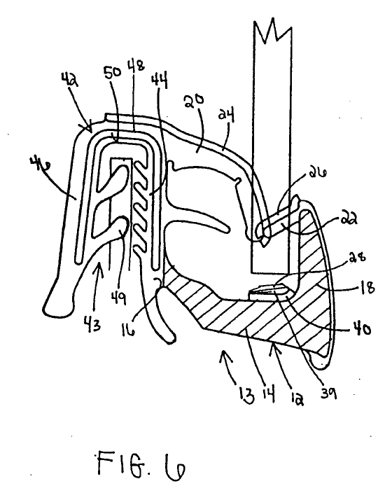

Yet another embodiment of this invention is shown in FIG. 6, where supported glass-run channel 13 includes U channel 12, first contact lip 20, second contact lip 22, bumper 40, and retention channel 42, which includes inboard leg 44, outboard leg 46, and shoulder support 48. Metal carrier 50 is incased or imbedded within retention channel 42. The interior 43 of retention channel 42 carries one or more retention portions 49.

In one or more embodiments, retention channel 42 of supported glass-run channel 13 is characterized by mechanical properties that allow retention channel 42 to be technologically useful in application. For example, retention channel 42 of one or more embodiments is characterized by an advantageous strength and durability. Accordingly, in one or more embodiments, the specific gravity of one or more elements of retention channel 42 (i.e., inboard leg 44, outboard leg 46, or shoulder 48) is characterized by a specific gravity, per ASTM D297, that is greater than (0.80, in other embodiments greater than 0.85, in other embodiments greater than 0.90, and still in other embodiments greater than 0.95. Yet in other embodiments, one or more elements of retention channel 42 are advantageously characterized by having a relatively low weight which derives from the fact that one or more elements (i.e., inboard leg 44, outboard leg 46, or shoulder support 48) are characterized by a specific gravity, per ASTM 0297, that is less than 0.80, in other embodiments less than about 0.75, and still other embodiments, less than about 0.70, in yet other embodiments less than about 0.65. As with the previous embodiments, at least one of the elements or components of U channel 12 of supported glass-run channel 13 is characterized by a relatively-low density in accordance with other embodiments of this invention.

Other supported glass-run channels are known in the art including, but not limited to, those that include “Schleggel wire” configurations, “Lance and Stretch” configurations, and “Fishbone” configurations.

Both supported and unsupported glass-run channels typically also include low-friction layers, which reduce resistive forces caused by the contacting of the window and the glass-run channel. Accordingly, in one or more embodiments, as shown in FIGS. 4-6, first contact lip 20 preferably carries a low-friction layer 24, and second contact lip 22 preferably carries a low-friction layer 26. As specifically shown in FIG. 4, wind-noise lip 30 preferably carries low-friction layer 32. Also, first retention portion 34 and second retention portion 36 may optionally carry low-friction layers 35 and 37, respectively. As specifically shown in FIGS. 5 and 6, bumper 40 carries low friction layer 28.

Low-friction layers 24, 26, and 32, as well as low friction layer 28, may include a slip coat, spray coat, flock, or flock tape. Useful slip coats typically include a thin polymeric layer or film as described in U.S. Pat. Nos. 5,110,685, 5,424,019, 5,343,655, 5,447,671, 5,441,685, 5,302,463, and 6,146,739, which are incorporated herein by reference. Preferred slip coats include polyalphaolefins, particularly blends of polyethylene resins.

The thickness of the slip coat may vary especially in view of the location. For example, the slip coat applied to a bumper, such as bumper 40, can vary between 70 and 100μ or 75 and 85μ. The slip coat applied to the bumper within the pillars, are optionally thicker than the slip coat applied to the header. In the case of the contact lips (e.g., first and second lips 20 and 22), the slip coat can vary between 150 and 350μ or 200 and 300μ. Likewise, the slip coat within the pillar portions may optionally be thicker than the slip coat in the header portion.

In one or more embodiments, the low friction layers are disposed on a boundary layer, The boundary layer advantageously provides a smooth surface upon which low-friction layers or slip coat can be applied or positioned. This is significant inasmuch as the low density elements are generally not smooth, which derives from their cellular nature. This is particularly advantages when low-friction layers include a slip coat. Accordingly, and with reference to FIG. 5, unsupported U channel 11 includes boundary layer 39 disposed between bumper 40 (which is characterized by a relatively low density) and low friction layer 28. In other optional embodiments, and as shown in FIG. 5, inboard leg 16 may optionally carry low friction layer 29. Boundary layer 39 is preferably disposed between inboard leg 16 and low friction layer 29.

Boundary layer 39 is preferably characterized by a relatively high specific gravity; the specific gravity is preferably greater than 0.80, more preferably greater than about 0.85, even more preferably greater than about 0.90, and still more preferably greater than about 0.95. As with first and second contact lips 20 and 22, the boundary layer 39 can comprise polymeric materials including those conventionally used in the art of making window channels. These materials include, but are not limited to, olefinic elastormeric copolymers such as EPDM and thermoplastic vulcanizates. The thickness of the boundary layer can vary, particularly based upon location and use. For example, the thickness of the boundary layer can vary from about 200 to about 400 s or from about 250 to about 350μ.

The window channels of this invention can be made by employing a variety of techniques. In a preferred embodiment, the window channels are made by employing a coextrusion or multi-extrusion techniques, which are known in the art. In one embodiment, all of the various components of the window channel are simultaneously extruded to form an integral window channel. In other words, the high density and low density components can be simultaneously formed with one another to create an integral glass-run channel wherein the multiple components are integral to one another, Likewise, the slip coat and optionally the boundary layer can be integral with those elements onto which they are disposed.

Various modifications and alterations that do not depart from the scope and spirit of this invention will become apparent to those skilled in the art. This invention is not to be duly limited to the illustrative embodiments set forth herein.

What is claimed is:

1. A glass-run channel comprising:
I) a U-channel including
a) a shoulder
b) an inboard leg
c) an outboard leg
wherein at least one of the shoulder, inboard leg, and outboard leg is characterized by a specific gravity of less than 0.85;
II) a first lip carried by the inboard leg; and
(III) a second lip carried by the outboard leg
wherein at least one of the first and second lips are characterized by a specific gravity of greater than about 0.80.

2. The glass-run channel of claim 1, further comprising a low-friction layer carried by at least one of the first or second lips.

3. The glass-run channel of claim 2, where the low-friction layer includes a slip coat, a spray coat, or a floc.

4. The glass-run channel of claim 1, where at least one of the shoulder, inboard leg, and outboard leg is characterized by a specific gravity of less than 0.80.

5. The glass-run channel of claim 1, where at least one of the shoulder, inboard leg and outboard leg is characterized by a specific gravity of less than 0.75.

6. The glass-run channel of claim 1, where at least one of the first and second lips are characterized by a specific gravity of greater than 0.85.

7. The glass-run channel of claim 1, where at least one of the first and second lips are characterized by a specific gravity of greater than 0.90.

8. The glass-run channel of claim 1, where at least one of the first and second lips are characterized by a specific gravity of greater than 0.95.

9. The glass-run channel of claim 3, further comprising a wind-noise lip.

10. The glass-run channel of claim 3, further comprising a bumper.

11. The glass-run channel of claim 10, wherein said bumper carries a slip coat.

12. The glass-run channel of 11, further comprising a boundary layer, and wherein said boundary layer is disposed on said bumper, and said slip coat is disposed on said boundary layer.

13. The glass-run channel of claim 1, where said shoulder includes an internal planar surface and an external planar surface, and wherein the glass-run channel further includes a boundary layer disposed on said internal planar surface of said shoulder.

14. The glass-run channel of claim 13, further comprising a slip coat disposed on said boundary layer.

15. The glass-run channel of claim 1, wherein at least one of said inboard leg and said outboard leg carries a slip coat.

16. The glass-run channel of claim 15, further comprising a boundary layer disposed between said slip coat and said outboard leg.

17. The glass-run channel of claim 1, wherein the glass run channel includes a support.

18. A glass-run channel comprising:
I) a U-channel including
a) a shoulder
b) an inboard leg
c) an outboard leg
wherein at least one of the shoulder, inboard leg, and outboard leg is characterized by a specific gravity of less than 0.85, and
II) at least one lip carried by at least one of said inboard leg and said outboard leg, wherein said at least one lip is characterized by a specific gravity of greater than about 0.80.
